(19) United States
(12) Patent Application Publication
(10) Pub. No.: US 2008/0202211 A1
(43) Pub. Date: Aug. 28, 2008

(54) Gas Sensor and Method For Operating a Getter Pump

(75) Inventor: Daniel Wetzig, Koln (DE)

Correspondence Address: MARJAMA MULDOON BLASIAK & SULLIVAN LLP, 250 SOUTH CLINTON STREET, SUITE 300, SYRACUSE, NY, 13202, US

(73) Assignee: Inficon GmbH, Koln (DE)

(21) Appl. No.: 11/632,112

(22) PCT Filed: Jul. 12, 2005
(86) PCT No.: PCT/EP05/53321

§ 371 Date: Dec. 28, 2007

(30) Foreign Application Priority Data
Jul. 16, 2004 (DE) 10 2004 034 381.0

(51) Int. Cl. G01M 3/20

(52) U.S. Cl. 73/40.7

(57) ABSTRACT

The invention relates to a gas sensor comprising a pump chamber (11) which is connected to a getter pump (30) by means of a throttle channel (20). The detection chamber (11) is closed by a wall (12, 13) that is selectively permeable only to hydrogen. The getter pump (30) sucks hydrogen out of the detection chamber (11). Hydrogen is detected by a highly sensitive pressure sensor (14) when it is diffused into the pump chamber (11) through the wall (12, 13). Said gas sensor has a simple structure and does not require a mass spectrometer.

The invention is directed to a gas sensor for detecting the presence of a trace gas, as well as a method for operating a getter pump for drawing off hydrogen to create a high vacuum.

It is known in leak detectors to detect the occurrence of a trace gas escaping from a leak in an otherwise closed housing. Generally, the trace gas used is helium or hydrogen. In both cases, the detection of the presence of a trace gas is achieved using a mass spectrometer. Mass spectrometers are very complex and expensive. Moreover they offer no possibility to distinguish D₂ from helium.

DE 100 31 882 A1 (Leybold Vakuum GmbH) describes a sensor for helium or hydrogen which comprises a vacuum-tight housing with a selectively acting passage for the gas to be detected. The housing is made of glass and the selectively acting passage is a membrane of a silicon material on which a silicon disc with through holes and a heating are provided. The housing accommodates a gas pressure sensor responding to the total pressure of the gas that has entered the housing. Thus, a rather simple gas pressure sensor can be used instead of a mass spectrometer.

EP 0 831 964 B1 (Leybold Vakuum GmbH) describes the manufacture of a selectively acting passage membrane for test gas detectors of leak detecting devices. A passage includes a silicon disc featuring a plurality of gas passage areas. The passage leads into a vacuum chamber connected to a vacuum measuring apparatus.

It is an object of the invention to provide a gas sensor for detecting the presence of a trace gas, which sensor is of simple structure and is highly sensitive and selective with respect to the trace gas.

The gas sensor of the present invention is defined by claim 1. It comprises a detection chamber with a wall selectively permeable to the trace gas, and a pump chamber including a getter pump receiving the trace gas. The detection chamber is connected with the pump chamber via a throttle channel. A pressure sensor located inside the detection chamber senses an increase in pressure caused by the intrusion of the trace gas.

The invention provides that the getter pump generates a high vacuum in the detection chamber. However, the getter pump is included in a pump chamber outside the detection chamber. As soon as trace gas enters into the detection chamber through the wall that is permeable only to the trace gas, an increase in pressure occurs that can not be dissipated at once by the getter pump due to the flow-inhibiting effect of the throttle channel. This increase in pressure is detected by the pressure sensor and can be taken as an indication for the detection of trace gas. The increased pressure in the detection chamber is dissipated with a delay, taking into consideration the time constant effected by the throttle channel so that, thereafter, the gas sensor is functional again.

Preferably, the gas sensor is configured such that it detects the presence of hydrogen. The pressure sensor contained in the detection chamber supplies a current that is dependent on the gas pressure. A suitable pressure sensor would be a sensor operating according to the Penning discharge principle, which supplies a current depending on the gas pressure. A Penning pressure sensor comprises two plate electrodes as cathodes and an anode ring arranged therebetween. When gas ions are present in the space between anode and cathode, they generate a detectable current. In this manner, very low gas pressures of less than 10⁻¹² mbar can be measured, however, with very small measuring currents in the order of 10⁻¹³ occurring. Thus, a high sensitivity of the trace gas detection can be achieved. Penning measuring cells are available from Inficon under the trade name “Penning Gauge PEG 100”.

Because the detection chamber is defined by a wall that is selectively permeable only to the trace gas, only the trace gas can enter into the detection chamber from the outside. The occurrence of a change in pressure in the detection chamber serves to detect the intrusion of trace gas, and the present gas sensor is suited for the detection of minute amounts of trace gas, because a high vacuum in the range of 10⁻¹² mbar can be generated by the getter pump. The pressure sensor used for gas pressure detection is considerably simpler than a mass spectrometer. It need not react selectively to a specific gas. Rather, it is sufficient to determine the total pressure in the detection chamber. Neither is it necessary to determine an absolute value, but it suffices to detect changes in pressure.

In a preferred embodiment of the invention, the wall that is selectively permeable to the trace gas, but is a barrier to other gases, is a membrane arranged on a support of silicon, for example. Preferably, the selectively permeable wall can be heated to increase permeability. To achieve this, the membrane itself may be used as a heating resistor, for example.

The invention provides a gas sensor of simple structure that can detect even minute partial pressures of the sample gas using simple means. The gas sensor is particularly suited for use in leak detection, wherein the escape of a trace gas from a container is detected.

The invention further refers to a method for operating a getter pump to draw off hydrogen, as defined in claim 7. According to this method, a getter material adsorbing hydrogen is heated for regeneration in an evacuatable receptacle that has a wall selectively permeable to hydrogen, so that hydrogen escapes into the atmosphere from the getter material through said wall.

In this method, the getter material forms a regenerative hydrogen pump. This method profits from the fact that, when heating the getter, previously adsorbed hydrogen migrates to the surface of the getter material so that the hydrogen is gassed outward. The other gases diffuse into the getter material upon heating. In the getter material, a balance between the absorption and the dissipation of H₂ molecules is established. The absorption is independent of the external pressure (partial pressure). The dissipation is temperature-dependent. When the getter material is heated, hydrogen is gassed out from this material and fills the volume of the receptacle. Thus, hydrogen escapes from the receptacle into the atmosphere. This means a regeneration of the getter material which is thus freed from hydrogen. The getter material is then able to receive new hydrogen to be pumped off.

The following is a detailed description of embodiments of the invention with reference to the drawings. These embodiments are not to be construed as being limitative of the scope of protection of the invention. Rather, the same is defined by the claims.

In the figures:

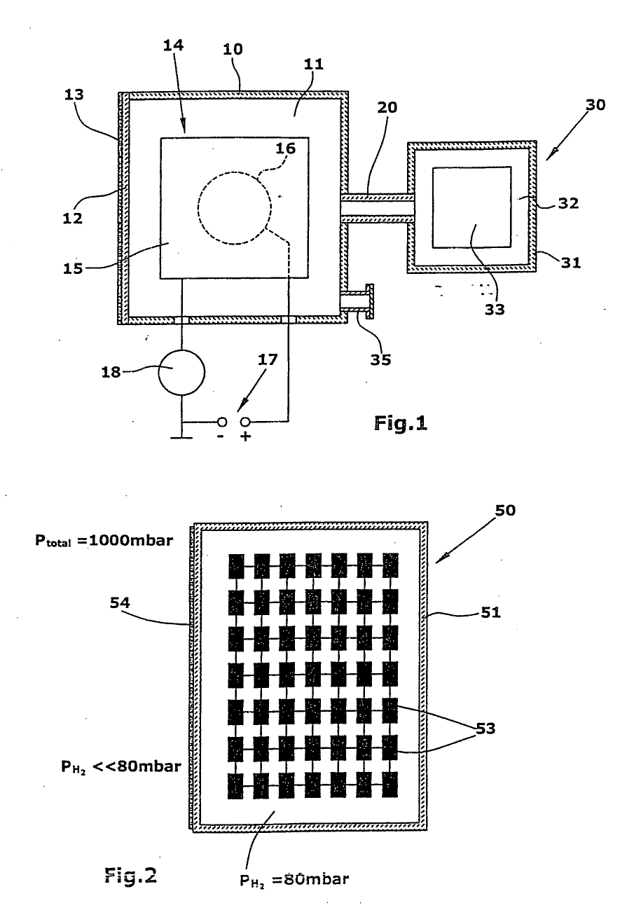

FIG. 1 is a schematic illustration of a gas sensor for detecting the presence of a sample gas, and

FIG. 2 illustrates a regenerative getter vacuum pump for pumping hydrogen.

FIG. 1 illustrates a gas sensor for a temperature-independent measurement of partial pressures of hydrogen. The gas sensor comprises a closed housing 10 of glass including a detection chamber 11. A wall 12 of the housing is also made of a support of porous silicon bonded to the glass of the housing. This support is covered by a thin membrane 13 of palladium. Palladium has the effect that it is permeable only to hydrogen and its isotopes (H₂, D₂, T₂, HD, HT and DT). For all other elements, its permeability is negligibly small.

A pressure sensor 14 in the form of a Penning pressure sensor is situated in the detection chamber 11. The pressure sensor 14 has two parallel cathode plates 15 mutually spaced from each other, only one of which being visible in FIG. 1. Between the cathode plates 15, an anode ring 16 is provided whose axis is orthogonal to the plane of the plates. A voltage source 17 supplies DC voltage applied between the cathode plates and the anode ring. A current measuring apparatus 18 is provided in the electric circuit for measuring the cathode or the anode current. The magnetic field necessary for a Penning discharge is generated by a permanent magnet arranged outside the closed housing 10.

The cathode plates 15 of the pressure sensor 14 are made from a material having as little of a suction effect on hydrogen as possible, such as aluminum. This ensures that the cathode surface is not enriched with hydrogen in operation. Thus, a permanence of the suction capacity is achieved that is almost exclusively determined by the getter pump 30.

A getter pump 30 is connected to the detection chamber 11 via a throttle channel 20, the pump generating a high vacuum in the detection chamber 11. The getter pump 30 has a chamber 32 in a sealed receptacle 31 of glass, which chamber contains a getter material 33. The getter material may be the getter ST707 manufactured by SEAS-Getters. It is highly adsorptive for hydrogen. Therefore, hydrogen is pumped from the detection chamber through the throttle channel 20.

When operating the gas sensor, the detection chamber 11 is first evacuated through an aspiration socket 35 and then closed so that a vacuum of 10⁻⁸ to 10⁻⁷ mbar, for example, prevails in the detection chamber. Thereafter, the getter material of the getter pump 30 is heated to the activation temperature of 500° C., for example, so that the getter pump 30 draws hydrogen from the detection chamber 11 and reduces the partial pressure of hydrogen to pressures lower than 10⁻¹² mbar. When hydrogen from the atmosphere enters into the detection chamber 11 through the heated wall 12 selectively permeable to hydrogen, the pressure in the detection chamber 11 increases because hydrogen can be drawn off through the throttle channel 20 only with a delay. This increase in pressure is detected by the pressure sensor 14 and is judged an intrusion of hydrogen.

At a temperature 300° C., a conductance through the membrane of LH2=1.3×10⁻¹ l/s for hydrogen is obtained for a membrane 13 of palladium having a thickness of 10 μm and a total surface area of 1 cm². The suction capacity of the getter pump 30 is limited to SH2=0.2 l/s by the throttle channel 20. An increase in hydrogen pressure in the vicinity of the sensor, i.e. in the atmosphere, to p=10⁻⁶ mbar causes an increase of the discharge current in the sensor by 3×10⁻¹⁰ A at a sensor time constant of t=100 ms. Here, a typical sensitivity of I=1 A/mbar for the cold cathode discharge and a sensor volume of 20 cm³ were assumed.

FIG. 2 illustrates a getter pump 50 generally configured the same as the getter pump 30 of FIG. 1. In a closed receptacle 50 of glass, the getter material 52 in the form of a plurality of getter pills 53 is located that are held by a grid. The getter material is a non-evaporatable NEG material (non evaporatable getter). These are materials whose pumping effect is triggered by heating. Gases adhere to the surface of the getter and diffuse into the individual getter particles during heating so that the reactive surfaces of the getter particles can afterwards receive further molecules. This process is reproducible until the solid body material has reached the saturation limit. This process is different only for noble gases and hydrogen. NEGs show no pumping effect with noble gases due to the inert behavior of noble gases.

Hydrogen is bound by the getter more weakly than other reactive gases. For hydrogen, an equilibrium pressure with the environment exists that depends on the getter temperature and the amount of hydrogen adsorbed by the getter. After adsorption of large amounts of hydrogen, the suction effect can not be regenerated by heating without gassed out hydrogen being dissipated during heating.

In the present instance, the getter material is the getter ST707 manufactured by SEAS-Getters. Other NED materials could also be used.

Referring to FIG. 2, the receptacle 51 is closed on one side by a thin heatable membrane 54 of palladium. Palladium is highly permeable only to hydrogen and its isotopes. For hydrogen, the getter pump 50 acts through this membrane 54.

The receptacle 51 is first evacuated once to a pre-vacuum pressure and is then closed. In this state, the getter is heated to 500° C., for example, so that the getter effect is triggered. In the active state of the getter material, all reactive gases adhere to the surface. Only hydrogen can flow through the palladium membrane 54 into the closed receptacle 51. Accordingly, only hydrogen is pumped from the environment of the receptacle 51 by the hydrogen pump. The pump is effective only for hydrogen, independent of the partial pressures of other gases in the environment.

When the hydrogen pump is manufactured, the volume is evacuated once to p<10⁻¹ mbar and is subsequently closed permanently by glassing. Then, the getter is activated by heating so that atmospheric gases present in the closed volume are pumped and also hydrogen is adsorbed to the getter material. In this state, only hydrogen is pumped from the environment of the pump because only hydrogen can flow into the pump volume through the palladium membrane. This is the normal operating condition.

After an adsorption of 1000 Torr l per gram of getter material, the pump should be regenerated. After an amount of hydrogen of 1000 Torr l/g has been adsorbed, the H₂ equilibrium pressure at a temperature of 50° C. is about 7×10⁻⁹ mbar. If the material is heated to 500° C. in this state, the pressure increases to 80 mbar. For a regeneration, hydrogen gas has to be removed at this temperature. During regeneration, hydrogen is pumped outside through the palladium membrane. When the pressure has dropped to 0.5 Torr at T=500° C., the remaining adsorbed amount of hydrogen corresponds to 25 Torr l/g. The equilibrium pressure for this remaining amount of hydrogen is p<10⁻¹² mbar at T=50° C.

FIG. 2 illustrates the pressure conditions during the regeneration of the getter material. Inside the receptacle 51, the partial pressure of hydrogen is P_{H2}=80 mbar, which at the same time is the total pressure in the receptacle. In the surrounding atmosphere, however, an atmospheric pressure of 1000 mbar prevails, the partial pressure of hydrogen P_{H2} being much lower than 80 mbar. Thus, hydrogen escapes from the receptacle 51 through the membrane 54. It has to be ensured that the gas surrounding the receptacle 51 is free of hydrogen. The regeneration cycle can be treated as frequently as desired. With an easily achievable conductance for hydrogen through the palladium membrane of about 1×10⁻³ liters per second, about one hour is needed for an amount of hydrogen of about 200 mbar l to be put through.

1. A gas sensor for detecting the presence of a trace gas, comprising a detection chamber (11) having a wall (12) selectively permeable to the trace gas, a pump chamber (32) including a getter pump (30) adsorbing the trace gas, and a throttle channel (20) connecting the detection chamber (11) with the pump chamber (32), a pressure sensor (14) included in the detection chamber (14) detecting a pressure increase caused by the intrusion of the trace gas.

2. The gas sensor of claim 1,
characterized in
that, according to the penning discharge principle, the pressure sensor (14) supplies a current that depends on the gas pressure.

3. The gas sensor of one of claims 1 or 2, characterized in that the selectively permeable wall (12, 13) is permeable to hydrogen and its isotopes.

4. The gas sensor of claim 3, characterized in that the wall (12) has a membrane (13) comprising palladium.

5. The gas sensor of claim 4, characterized in that the membrane (13) is arranged on a support of silicon bonded to the detection chamber of glass.

6. The gas sensor of one of claims 1 to 5, characterized in that the selectively permeable wall is heatable.

7. A method for operating a getter pump (30; 50) for drawing off hydrogen, wherein a hydrogen-absorbing getter material (33; 53) in a receptacle (51) having a wall (12; 54) selectively permeable to hydrogen is heated for regeneration so that the hydrogen dissipates from the getter material through said wall into the atmosphere.

8. The method of claim 7, characterized in that the wall (12, 13; 54) is heated.
